(19) United States
(12) Patent Application Publication
(10) Pub. No.: US 2025/0087787 A1
(43) Pub. Date: Mar. 13, 2025

(54) Battery Pack Including Cooling Member and Device Including the Same

(71) Applicant: LG Energy Solution, Ltd., Seoul (KR)

(72) Inventors: Jae Ho Um, Daejeon (KR); Sang Kyu Choi, Daejeon (KR); Sukmyung Roh, Daejeon (KR)

(73) Assignee: LG Energy Solution, Ltd., Seoul (KR)

(21) Appl. No.: 18/960,110

(22) Filed: Nov. 26, 2024

Related U.S. Application Data
(63) Continuation of application No. 17/283,126, filed on Apr. 6, 2021, now abandoned.

(30) Foreign Application Priority Data
Nov. 16, 2018 (KR) 10-2018-0141847

(51) Int. Cl. H01M 10/6567; H01M 10/613; H01M 10/6556; H01M 50/204; H01M 50/271

(52) U.S. Cl. CPC H01M 10/6567; H01M 10/613; H01M 10/6556; H01M 50/204; H01M 50/271

(57) ABSTRACT

A battery pack according to one embodiment of the present disclosure includes: a housing in which at least one battery cell or battery module is built, a heat exchange member provided inside the housing to cool the battery cell or the battery module, a refrigerant inflow port and a refrigerant outflow port connected to the heat exchange member, and a rapid cooling member installed in the refrigerant inflow port.

### CROSS-REFERENCE TO RELATED APPLICATIONS

This application is a continuation of U.S. application Ser. No. 17/283,126 filed Apr. 6, 2021, which is a national phase entry under 35 U.S.C. §371 of International Application No. PCT/KR2019/015457 filed Nov. 13, 2019, which claims priority from Korean Patent Application No. 10-2018-0141847 filed on Nov. 16, 2018, the disclosure of which is incorporated herein by reference in its entirety.

### TECHNICAL FIELD

The present disclosure relates to a battery pack, and more particularly, to a battery pack including a cooling member.

### BACKGROUND ART

Secondary batteries, which are easily applied to various product groups and have electrical characteristics such as high energy density, are universally applied not only to portable devices but also to electric vehicles (EV) or a hybrid electric vehicles (HEV), energy storage systems or the like, which are driven by an electric driving source. The secondary battery is attracting attention as a new environmentally-friendly energy source for improving energy efficiency since it provides a primary advantage of remarkably reducing the use of fossil fuels and also does not generate by-products from the use of energy at all.

A battery pack for use in electric vehicles has a structure in which a plurality of cell assemblies, each including a plurality of unit cells, are connected in series to obtain a high output. In addition, the unit cell can be repeatedly charged and discharged by electrochemical reactions among components, which include a positive electrode current collector, a negative electrode current collector, a separator, an active material, an electrolyte and the like.

Meanwhile, recently, as the need for a large capacity structure has been increasing along with the utilization as an energy storage source, there is a growing demand for a battery pack with a multi-module structure in which a plurality of battery modules, each including a plurality of secondary batteries connected in series and/or in parallel, are integrated.

Since the battery pack with a multi-module structure is manufactured in a form in which a plurality of secondary batteries are densely packed in a narrow space, it is important to easily dissipate heat generated by each of the secondary batteries. As one of various methods for dissipating the heat generated by the secondary battery, Korean Unexamined Patent Publication No. 10-2016-0109679 (hereinafter referred to as ‘Prior Art Document 1’) discloses a battery pack having a configuration in which a battery module and a cooling plate for cooling the same are provided in a housing.

However, if the cooling plate is installed together inside the battery housing as in Prior Art Document 1, heat can be quickly discharged, but this method has a limitation in that the cooling efficiency is not high.

### DETAILED DESCRIPTION OF THE INVENTION

### Technical Problem

It is an object of the present disclosure to provide a battery pack capable of increasing cooling efficiency.

However, the problem to be solved by the embodiments of the present disclosure is not limited to the above-described problems, and can be variously expanded within the scope of the technical idea included in the present disclosure.

### Technical Solution

According to one embodiment of the present disclosure, there is provided a battery pack comprising: a housing in which at least one battery cell or battery module is built, a heat exchange member provided inside the housing to cool the battery cell or the battery module, a refrigerant inflow port and a refrigerant outflow port connected to the heat exchange member, and a rapid cooling member installed in the refrigerant inflow port.

Each of the refrigerant inflow port and the refrigerant outflow port has a structure protruding from the surface of the housing to the outside of the housing, and the rapid cooling member may be installed on the outside of the refrigerant inflow port.

The rapid cooling member may be formed to at least partially cover the outer surface of the refrigerant inflow port.

The length of the refrigerant inflow port protruding from the housing may be longer than the length of the refrigerant outflow port protruding from the housing.

The cross-sectional area of the refrigerant inflow port may be larger than that of the refrigerant outflow port.

An inclined surface may be formed on a bottom surface of the housing.

A support rib may be protruded at a portion where the inclined surface is formed on the bottom surface of the housing so as to support a heat exchange member.

The temperature of the refrigerant flowing into the housing through the refrigerant inflow port may be maintained at 20 degrees Celsius to 30 degrees Celsius by the rapid cooling member.

Port holes through which the refrigerant inflow port and the refrigerant outflow port respectively pass are formed in the housing; a sealing portion into which a skirt portion of the heat exchange member is inserted is formed on the bottom surface of the housing; and the bottom surface of the housing may be formed to have an inclined surface that is gradually lowered from the sealing portion toward the port hole so that a leaked refrigerant can be discharged through the port hole.

A device according to another embodiment of the present disclosure includes the above-mentioned battery pack.

### Advantageous Effects

According to the embodiments, it is possible to realize a battery pack capable of substantially increasing cooling efficiency by installing a rapid cooling member directly into a refrigerant inflow port located outside the battery pack.

### BRIEF DESCRIPTION OF THE DRAWINGS

FIG. 1 is an exploded perspective view illustrating an internal configuration of a battery pack according to one embodiment of the present disclosure.

FIG. 2 is an exploded perspective view illustrating an external configuration of the battery pack of FIG. 1.

FIG. 3 is a perspective view of the bottom of the housing included in the battery pack of FIG. 1.

FIG. 4 is a bottom plan view illustrating a bottom surface of a housing included in the battery pack of FIG. 1.

FIG. 5 is a top plan view illustrating a state in which a heat exchange member is coupled to a housing included in the battery pack of FIG. 1.

FIG. 6 is a perspective view of the bottom of the housing included in the battery pack according to another embodiment of the present disclosure.

FIG. 7 is a perspective view of the bottom of the housing included in the battery pack according to yet another embodiment of the present disclosure.

### DETAILED DESCRIPTION OF THE EMBODIMENTS

Hereinafter, various embodiments of the present disclosure will be described in detail with reference to the accompanying drawings so that those skilled in the art can easily implement them. The present disclosure may be modified in various different ways, and is not limited to the embodiments set forth herein.

Parts that are irrelevant to the description will be omitted to clearly describe the present disclosure, and like reference numerals designate like elements throughout the specification.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element and intervening elements may also be present. In contrast, when an element is referred to as being “directly on” another element, it means that other intervening elements are not present. Further, the word “on” or “above” means disposed on or below a reference portion, and does not necessarily mean being disposed on the upper side of the reference portion toward the opposite direction of gravity.

Further, throughout the specification, when a part is referred to as “including” a certain component, it means that it can further include other components, without excluding the other components, unless otherwise stated.

Further, throughout the specification, when referred to as “planar”, it means when a target portion is viewed from the top, and when referred to as “cross-sectional”, it means when a target portion is viewed from the side of a cross section cut vertically.

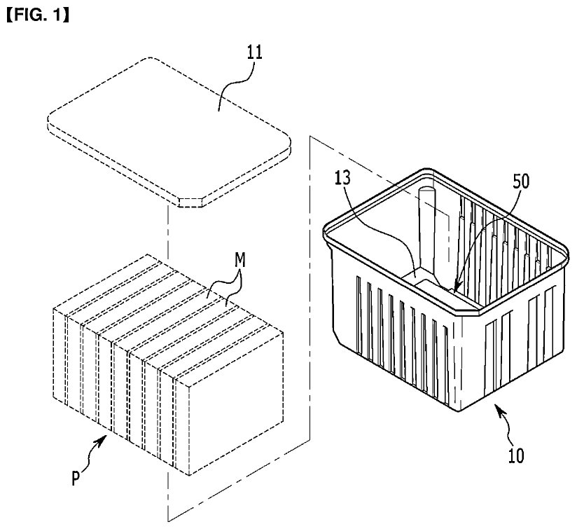

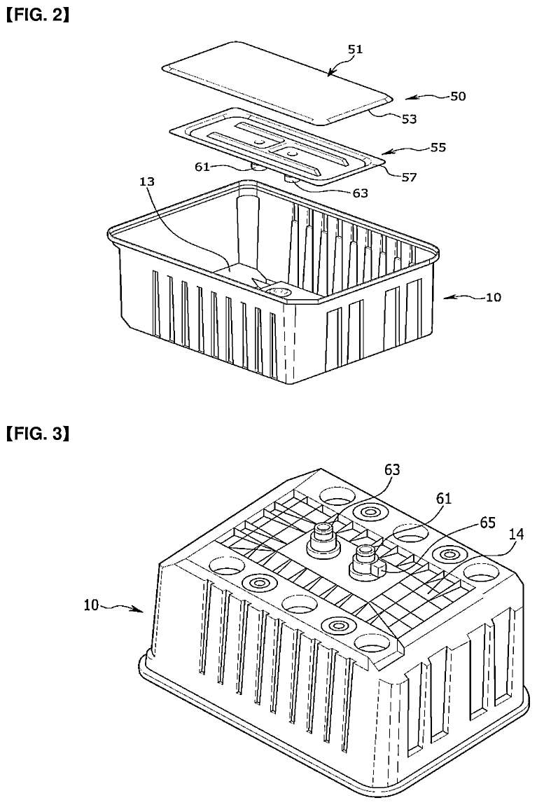

FIG. 1 is an exploded perspective view illustrating an internal configuration of a battery pack according to one embodiment of the present disclosure. FIG. 2 is an exploded perspective view illustrating an external configuration of the battery pack of FIG. 1. FIG. 3 is a perspective view of the bottom of the housing included in the battery pack of FIG. 1.

Referring to FIGS. 1 and 2, a battery pack according to the present embodiment may include a housing 10, a battery module M accommodated in the housing 10, and a cover covering the accommodated battery module M. Before the battery module M is accommodated, a heat exchange member 50 is installed on a bottom side of the housing 10.

The housing 10 may have a hexahedral structure with an opened upper part, and a cover 11 may be coupled to the upper part of the housing 10. The shape and structure of the housing 10 are not limited to those illustrated in the figures, and may be variously modified according to the implementation conditions as long as they are structures in which the battery cells or battery modules can be installed.

A plurality of battery modules M may be installed inside the housing 10. For example, as shown in FIG. 1, vertically erected battery modules M may be continuously arranged.

A heat exchange member 50 is installed on the bottom surface 13 of the housing 10 to adjust the temperature of the battery modules M. The heat exchange member 50 is a main component of a cooling system, and is configured to allow a refrigerant to pass therethrough, thereby adjusting the temperature of the battery module M.

The heat exchange member 50 may be formed into a cooling plate-type structure in which an upper plate 51 and a lower plate 55 are coupled to allow the refrigerant to pass therein, as shown in FIG. 2. The upper plate 51 is configured to make contact with the battery module M or the like disposed at an upper portion via a heat transfer member, etc., and the lower plate 55 is configured to be connected to a refrigerant inflow port 61 and a refrigerant outflow port 63 through which the refrigerant inflows and outflows, respectively.

The upper plate 51 and the lower plate 55 may be formed into a square planar structure having a certain thickness as shown in the figure, and may be also configured such that the circumferential edge portions thereof are joined together to allow the refrigerant to flow therein.

The lower plate 55 may be formed into a pan-like structure having a certain depth, and a flange portion 57 may be formed in a horizontal direction at the edge portion. The upper plate 51 may be formed into a planar structure, and may be formed in a structure in which the circumferential edge portion is more extended than the flange portion 57 of the lower plate 55. In particular, a skirt portion 53 bent downward may be formed at the circumferential edge end of the upper plate 51.

The joining structure between the upper plate 51 and the lower plate 55 is formed into a structure in which the flange portion 57 of the lower plate 55 and the bottom surface of the upper plate 51 making contact with the flange portion 57 are joined to each other in a state where the upper plate 51 is placed on the lower plate 55. With this structure, the heat exchange member 50 through which the refrigerant passes can be configured.

The skirt portion 53 formed on the circumferential edge portion of the upper plate 51 is configured to be inserted into or coupled to a sealing portion 20 of the housing 10 as described below.

Referring to FIG. 3, a rapid cooling member 65 is installed in the refrigerant inflow port 61 included in the battery pack according to the present embodiment. The rapid cooling member 65 functions to directly lower the temperature of the refrigerant in order to solve the problem associated with heat generation which has a limitation only by the development of the cell itself. In this case, if the temperature of the refrigerant becomes too low, the lifespan and efficiency of the battery cell may be rather reduced. In the present embodiment, however, in order to prevent the performance of the battery from dropping rapidly, the temperature of the refrigerant flowing into the housing 10 through the refrigerant inflow port 61 can be adjusted so as not to drop to a temperature of less than about 20 degrees Celsius. In other words, the temperature of the refrigerant flowing into the housing 10 through the refrigerant inflow port 61 can be maintained at 20 degrees Celsius to 30 degrees Celsius by the rapid cooling member 65. This is because, when the rapid cooling is performed on the outside, the cooling efficiency can be controlled by adjusting the area of the refrigerant inflow port 61, the time for performing the rapid cooling, etc. The temperature of a general refrigerant flowing into the refrigerant inflow port 61 may be approximately 40 degrees Celsius to 50 degrees Celsius.

The temperature range of the refrigerant flowing into the housing 10 through the refrigerant inflow port 61 as described above is one example, and may be slightly different depending on the type and performance of the battery cell, the refrigerant temperature range and refrigerant circulation speed of a vehicle, etc. equipped with the battery pack according to the present embodiment, etc. In other words, the upper and lower limits of the refrigerant temperature range can be adjusted depending on the amount of heat generated.

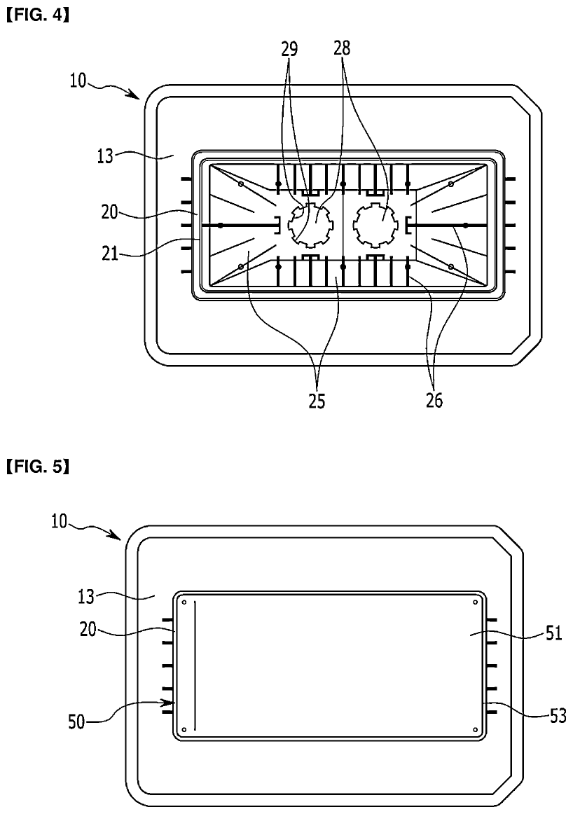

FIG. 4 is a bottom plan view illustrating a bottom surface of a housing included in the battery pack of FIG. 1. FIG. 5 is a top plan view illustrating a state in which a heat exchange member is coupled to a housing included in the battery pack of FIG. 1.

Referring to FIGS. 4 and 5, a sealing portion 20, into which the skirt portion 53 of the heat exchange member 50 is inserted, is formed on a bottom surface 13 of the housing 10. When the circumferential surface of the heat exchange member 50 is formed in a square shape as in the present embodiment, it is preferable that the sealing portion 20 is also formed in a square shape.

The sealing portion 20 is formed into a groove structure and is preferably formed into a structure in which the skirt portion 53 of the heat exchange member 50 is inserted and fitted, but it is also possible to configure into a structure in which an inner wall 21 is removed from the sealing portion 20.

The lower surface 14 of the housing 10 is formed such that the central portion thereof protrudes downward as shown in FIGS. 3 and 4; and port holes 28 are formed at the lowest portion of the lower surface 14 such that the refrigerant inflow port 61 and the refrigerant outflow port 63 connected by the heat exchange member 50 are respectively inserted therein.

The bottom surface 13 of the housing 10 is preferably formed to have an inclined surface 25 that is gradually lowered from the sealing portion 20 toward the port hole 28 so that a leaked refrigerant which may possibly occur, can be discharged through the port hole 28.

In this case, the portion where the inclined surface 25 is formed is preferably configured such that a support rib 26 is protruded upward so as to support the lower surface of the heat exchange member 50. The support rib 26 is preferably disposed in a radial arrangement formed around the port hole 28 to perform a smooth discharge of the leaked refrigerant, as shown in FIG. 4.

The reason why the bottom surface 13 of the housing 10 is inclined in this way is in case the refrigerant leaks from the heat exchange member 50, in which case the leaked refrigerant is to smoothly discharged out of the housing 10 through a port hole 28 after the leaked refrigerant flows along the inclined surface.

Although this embodiment illustrates a structure in which the leaked refrigerant flows downward via the structure of the inclined surface 25, it is also possible to form a discharging flow path on the bottom surface 13 of the housing 10 without forming an inclined surface so that the leaked refrigerant is discharged.

The port hole 28 may be configured to form a gap or hole in a state where the inlet port 61 or the outlet port 63 is installed so that the leaked refrigerant is discharged smoothly. To this end, the inner surface of the port hole 28 may be formed into an uneven structure 29 as shown in FIG. 4. Alternatively, it is also possible to configure a portion for discharging the leaked refrigerant to the outside of the housing 10 by forming a separate hole on the bottom surface 13 of the housing 10 rather than the port hole 28.

Meanwhile, in the above description and figures, the heat exchange member 50 having a cooling plate structure has been described, but the present disclosure is not limited thereto. If it is a pack-type or cylindrical structure in which refrigerant flows therein, it may be configured by applying a structure to the present disclosure for blocking the inflow of the leaked refrigerant according to various known heat exchange members.

The battery pack according to the present embodiment may use a water-cooled type cooling system. In the case of the water-cooled type cooling system, the radiator and the battery pack are connected to each other, so that the low-temperature refrigerant of the radiator can be sent to the battery pack and heat-changed to cool the battery pack, and the refrigerant whose temperature has risen due to heat exchange can be sent back to the radiator.

In general, the basic concept for cooling can be represented by the following Equations 1 and 2:

$$Cooling = {Q}_{heating} - {Q}_{cooling} \qquad Equation ( 1 )$$

$${Q}_{cooling} = ( {T}_{coolant} + {T}_{cell} ) / {R}_{heat} \qquad Equation ( 2 )$$

wherein, Q_{heating} is the amount of heat generated in the battery pack, Q_{cooling} is the cooling heat generated in the battery pack, T_{coolant} is the temperature of the refrigerant, T_{cell} is the temperature of the battery cell itself, and Rₕₑₐₜ is the heat of resistance.

Theoretically, heat can be applied by I²R (where I is current, R is resistance), but more heat may inevitably be generated in order to enhance fuel efficiency by increasing a current consumption and to use a single battery pack in vehicles of several classes. When the environment in which the battery is used becomes a high temperature environment due to heat generation, most of the battery life is rapidly shortened and the risks of use increase. Further, even if the resistance is drastically lowered to enhance the performance of the battery, the current consumption increases at the same time and, therefore, the problem of heat generation is hardly resolved by the development of the battery cell.

The maximum temperature of the battery cell or battery module or battery pack according to the current is not determined depending on the ambient temperature, but is determined depending on the temperature of the refrigerant and the battery cell itself. Therefore, according to an embodiment of the present disclosure, it is possible to effectively lower the practical use temperature. Specifically, according to the present embodiment, a rapid cooling member 65 is installed in the refrigerant inflow port 61 as shown in FIG. 3.

The rapid cooling member 65 according to the present embodiment can be installed in the refrigerant inflow port 61 to directly cool the refrigerant flowing into the battery pack. Since the rapid cooling member 65 is installed on the outside of the battery pack in this way, it does not affect the temperature of the battery pack. Heat generated due to cooling may escape through the refrigerant outflow port 63.

According to an embodiment of the present disclosure, the cooling system based on a structure in which the rapid cooling member 65 is installed in the refrigerant inflow port 61 is capable of directly lowering the T_{coolant}, and this method can affect even the T_{cell}, thereby increasing a substantial cooling effect. Cooling by a cooling fin and a perimeter, which have frequently been used in the past, is a method of cooling by merely sending the generated heat to the outside, that is, by controlling only Rₕₑₐₜ. However, the method according to an embodiment of the present disclosure is a cooling method that simultaneously affects not only Rₕₑₐₜ but also T_{cell} and T_{coolant}. Therefore, according to the cooling method of the present embodiment, the cooling efficiency can be greatly improved compared to the conventional method.

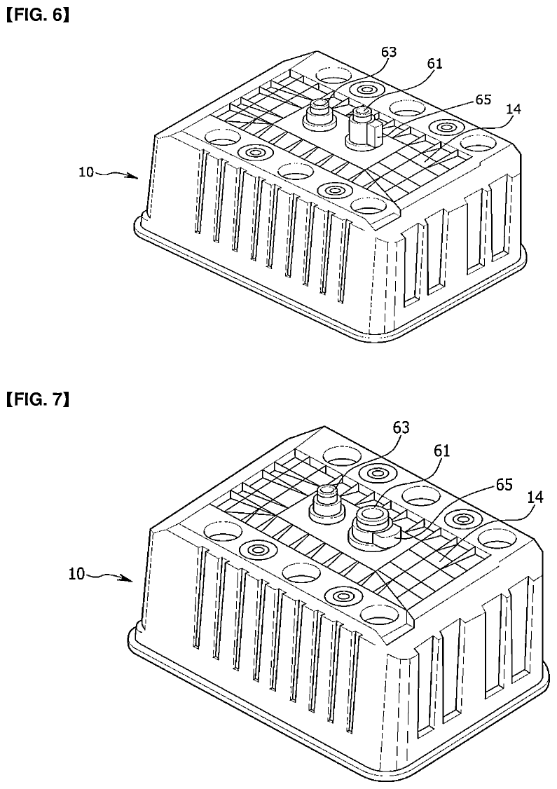

FIG. 6 is a perspective view of the bottom of the housing included in the battery pack according to another embodiment of the present disclosure. FIG. 7 is a perspective view of the bottom of the housing included in the battery pack according to yet another embodiment of the present disclosure.

When the refrigerant is cooled using the rapid cooling member according to the present embodiment, the temperature of the cooled refrigerant can be further lowered by adjusting at least one of the length and area of the refrigerant inflow port 61. Specifically, referring to FIG. 6, the temperature of the refrigerant flowing into the battery pack can be further reduced by increasing the length of the refrigerant inflow port 61. In this case, together with increasing the length of the refrigerant inflow port 61, the length of the rapid cooling member 65 installed in the refrigerant inflow port 61 may also be formed long.

In addition, referring to FIG. 7, the temperature of the refrigerant flowing into the battery pack can be further reduced by increasing the cross-sectional area of the refrigerant inflow port 61. Here, the cross-sectional area may mean an area of a surface cut in a direction perpendicular to the longitudinal direction (refrigerant inflow direction) of the refrigerant inflow port 61. In this case, together with increasing the cross-sectional area of the refrigerant inflow port 61, the area of the rapid cooling member 65 installed in the refrigerant inflow port 61 may also be formed large.

The above-mentioned the battery pack can be applied to various devices. Such devices include, but are not limited to, transportation means such as an electric bicycle, an electric vehicle, and a hybrid vehicle, and the present disclosure is applicable to various devices capable of using any battery module and any battery pack including the same, which also falls under the scope of the present disclosure.

Although the preferred embodiments of the present disclosure have been described in detail above, the scope of the present disclosure is not limited thereto, and various modifications and improvements of those skilled in the art using the basic concepts of the present disclosure defined in the following claims also belong to the scope of rights.

### DESCRIPTION OF REFERENCE NUMERALS

10: housing

25: inclined surface

26: support rib

50: heat exchange member

61: refrigerant inflow port

63: refrigerant outflow port

65: rapid cooling member

1. A battery pack comprising:
a housing including at least one battery cell or battery module therein;
a heat exchange member disposed inside the housing for cooling the battery cell or the battery module;
a refrigerant inflow port and a refrigerant outflow port connected to the heat exchange member; and
a rapid cooling member positioned in the refrigerant inflow port,
wherein each of the refrigerant inflow port and the refrigerant outflow port has a structure protruding out of the housing from an outer surface of the housing, and
wherein the rapid cooling member at least partially covers the outer surface of the refrigerant inflow port.

2. The battery pack of claim 1, wherein a length of the refrigerant inflow port protruding from the housing is longer than a length of the refrigerant outflow port protruding from the housing.

3. The battery pack of claim 1, wherein a cross-sectional area of the refrigerant inflow port is larger than a cross-sectional area of the refrigerant outflow port.

4. The battery pack of claim 1, wherein a bottom surface of the housing includes an inclined surface.

5. The battery pack of claim 4, wherein a support rib protrudes from the inclined surface so as to support the heat exchange member.

6. The battery pack of claim 1, wherein the rapid cooling member is configured to maintain the temperature of the refrigerant flowing into the refrigerant inflow port at 20 degrees Celsius to 30 degrees Celsius.

7. The battery pack of claim 1, wherein the refrigerant inflow port and the refrigerant outflow port pass through a respective port hole in the housing, and a bottom surface of the housing has a sealing portion coupled to a skirt portion of the heat exchange member; and
the bottom surface of the housing has an inclined surface that gradually slopes from the sealing portion toward the port holes so that a leaked refrigerant can be discharged through at least one of the port holes.

8. A device comprising the battery pack according to claim 1.

9. A battery pack comprising:
a housing including at least one battery cell or battery module therein;
a heat exchange member disposed inside the housing for cooling the battery cell or the battery module;
a refrigerant inflow port and a refrigerant outflow port connected to the heat exchange member; and
a rapid cooling member positioned in the refrigerant inflow port,
wherein each of the refrigerant inflow port and the refrigerant outflow port has a structure protruding out of the housing from an outer surface of the housing, and
wherein a length of the refrigerant inflow port protruding from the housing is longer than a length of the refrigerant outflow port protruding from the housing.

10. The battery pack of claim 9, wherein the rapid cooling member at least partially covers an outer surface of the refrigerant inflow port.

11. The battery pack of claim 9, wherein a cross-sectional area of the refrigerant inflow port is larger than a cross-sectional area of the refrigerant outflow port.

12. The battery pack of claim 9, wherein a bottom surface of the housing includes an inclined surface.

13. The battery pack of claim 12, wherein a support rib protrudes from the inclined surface so as to support the heat exchange member.

14. The battery pack of claim 9, wherein the rapid cooling member is configured to maintain the temperature of the refrigerant flowing into the refrigerant inflow port at 20 degrees Celsius to 30 degrees Celsius.

15. The battery pack of claim 9, wherein the refrigerant inflow port and the refrigerant outflow port pass through a respective port hole in the housing, and a bottom surface of the housing has a sealing portion coupled to a skirt portion of the heat exchange member; and
the bottom surface of the housing has an inclined surface that gradually slopes from the sealing portion toward the port holes so that a leaked refrigerant can be discharged through at least one of the port holes.

16. A device comprising the battery pack according to claim 9.

17. A battery pack comprising:
a housing including at least one battery cell or battery module therein;
a heat exchange member disposed inside the housing for cooling the battery cell or the battery module;
a refrigerant inflow port and a refrigerant outflow port connected to the heat exchange member; and
a rapid cooling member positioned in the refrigerant inflow port,
wherein a bottom surface of the housing includes an inclined surface.

18. The battery pack of claim 17, wherein a support rib protrudes from the inclined surface so as to support the heat exchange member.

19. The battery pack of claim 17, wherein the refrigerant inflow port and the refrigerant outflow port pass through a respective port hole in the housing, and the bottom surface of the housing has a sealing portion coupled to a skirt portion of the heat exchange member; and
the inclined surface bottom of the bottom surface of the housing gradually slopes from the sealing portion toward the port holes so that a leaked refrigerant can be discharged through at least one of the port holes.

20. A device comprising the battery pack according to claim 17.
